(19) United States
(12) Patent Application Publication
(10) Pub. No.: US 2011/0106780 A1
(43) Pub. Date: May 5, 2011

(54) METHOD AND APPARATUS FOR ACCESSING DATA IN A DATA STORE

(75) Inventors: José Antonio Martinez Heras, Darmstadt (DE); Rainer Timm, Seeheim-Jugenheim (DE); David Evans, Frankfurt am Main (DE)

(73) Assignee: EUROPEAN SPACE AGENCY, Paris Cedex 15 (FR)

(21) Appl. No.: 12/613,378

(22) Filed: Nov. 5, 2009

(51) Int. Cl. G06F 17/30

(52) U.S. Cl. 707/705; 707/E17.001

(57) ABSTRACT

A method and apparatus for accessing messages y contained in a data store 100 is provided. The method comprises the steps of determining a number of messages y of a predetermined message type forming a structure S consisting of a plurality of said messages y of the predetermined message type in the data store 100, selecting the structure, reading a first bit x of each message y of said structure consecutively, and reading a subsequent bit x+n of each message y of said structure consecutively until a final bit x of each message is read. The apparatus comprises determining means for determining a number of messages y of a predetermined message type forming a structure S consisting of a plurality of said messages y of the predetermined message type in the data store 100, selecting means for selecting the structure, reading means for reading a first bit x of each message y of said structure consecutively, and reading means for reading a subsequent bit x+n of each message y of said structure consecutively until a final bit x of each message y is read. Further, a system for accessing messages y contained in a data store 100 is provided, comprising the above mentioned apparatus for accessing messages y contained in a data store 100, a data store 100 and an encoding means.

### TECHNICAL FIELD

Embodiments of the invention generally relate to a method and apparatus for accessing messages contained in a data store, and more specifically to a method and apparatus for accessing a CCSDS housekeeping data store on-board a spacecraft.

### BACKGROUND

Compression of science data for space missions is an established technique whereas data compression of housekeeping telemetry is rare. The most common way of transporting housekeeping telemetry data today is using CCSDS (consultative committee for space data systems) packets. These packets are very efficient in the sense that they use position to determine content labels and they do not duplicate timing information (the same time or a pre-determined offset is applied to all the contents of a packet). However they are not efficient in terms of the header overhead if the packet is small. They must also allocate a sufficiently large number of bits for each parameter value to cover its possible range, which introduces inefficiencies.

Traditionally packets are stored in areas of memory in the order that they are generated. These areas of memory, known as packet stores, are sectioned to allow different types of packets to be stored there. Individual CCSDS housekeeping telemetry packets correlate to subsystems so they are a mix of different parameters and data types. The field length for each parameter is fixed but the length varies for each one. Different packets are then written into the same data store in time generated order. This causes more mixing of data types. The result is that a typical packet store contains a mix of many different packets arranged in generation time order. When transmission time comes, the stored packets are read back in exactly the same order. Therefore it is difficult to compress CCSDS housekeeping telemetry packets using simple algorithms.

CCSDS science data packets are currently compressed using the RICE algorithm. However, compression of recorded housekeeping telemetry stored in the form of CCSDS packets on-board spacecraft is not performed. This is because the RICE algorithm does not compress housekeeping telemetry data well. RICE does not perform well on housekeeping data because it is optimized to work on groups of bits (8, 16, 32 . . . ). As the field lengths of different parameters in a housekeeping packet vary, it cannot exploit the underlying varying structure. It is rather optimized for other data types such as images which can be split like this. Other compression algorithms such as 7zip or winzip have been suggested for use on housekeeping data, but they require complicated code to be loaded into the spacecraft's memory and require a relatively high level of processing power. Compression of housekeeping telemetry data would produce major benefits in some cases but to be worth it must use very simple algorithms and require little on-board processing power.

### SUMMARY OF THE INVENTION

Embodiments of the invention provide a method for accessing messages contained in a data store, preferably located on-board a spacecraft, the method comprising determining a number of messages of a predetermined message type forming a structure consisting of a plurality of said messages of the predetermined message type in the data store, selecting the structure, reading a first bit of each message of said structure consecutively, and reading a subsequent bit of each message of said structure consecutively until a final bit of each message is read. After the final bit of each message of the structure has been read, an identifier can be added indicating that said number of messages of the structure were read. The above mentioned steps according to the method for accessing messages contained in the data store can be performed for each structure in the data store. Further, each of said messages of the predetermined message type preferably comprises a predetermined message field pattern.

By accessing the messages in the data store, a bit stream can be created. The method for accessing messages contained in the data store is preferably performed by a reader. The reader can then pass the bit stream to an encoding means for compression, preferably a run length encoder. Accessing the data store in this way makes the outgoing data stream highly compressible using very simple compression algorithms, which can deal with long sets of identical consecutive values, such as run length encoding. This reduces the on-board software required and the use of on-board resources such as processing power.

The method is especially suited to missions in which the housekeeping data stream is separated from the science data stream, and/or in which it is a large proportion of the bandwidth and/or in which the transmission power is a constraint. This includes science missions with long cruise phases, technology demonstrator missions and small satellites. The method can be used to reduce contact times with the spacecraft or decrease power/energy requirements on-board for the transmission or increase the robustness of the ground/space link or increase the speed at which information is available on the ground or combinations of the above. It can also reduce the engineering effort required to optimize the packets to remove redundant information as this is done automatically.

Additional benefits of this pre-compression processing of messages contained in the data store can be that data stores can be compressed as soon as they reach a specified size. There is no need to keep the original messages, so these can be deleted to reduce on-board memory usage.

Compressed packet stores can be stored on-board for longer before they are overwritten. This can be exploited by reducing the contact frequency. It also means the chances to re-dump missing messages can be improved. The messages can be sent through a ground station to a mission control system in their compressed form. This can further increase the speed of delivery and improve reaction times.

When selecting the structure, the messages contained in the structure can be read according to the time generated order of the messages in the message store. The bit stream can exploit a structured nature of CCSDS housekeeping packets when applied to housekeeping data required for spacecraft control.

The data store can be a packet store and the messages contained in the data store can be data packets, wherein the data packets can comprise CCSDS housekeeping data. Each message can be fixed in length and can consist of fields fixed in position and bit length. Each message field preferably corresponds to a measurement, wherein the measurement can be performed by a sensor, an instrument or a device monitor.

Embodiments of the invention further provide an apparatus for accessing messages contained in a data store, comprising determining means for determining a number of messages of a predetermined message type forming a structure consisting of a plurality of said messages of the predetermined message type in the data store, selecting means for selecting the structure, reading means for reading a first bit of each message of said structure consecutively, and reading means for reading a subsequent bit of each message of said structure consecutively until a final bit of each message is read. The apparatus for accessing messages contained in a data store can be formed by a reader.

Embodiments of the invention further provide a system for accessing messages contained in a data store, comprising the above mentioned apparatus for accessing messages contained in a data store, a data store and an encoding means.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a schematic diagram of a method and system for accessing packets contained in a data store according an embodiment of the present invention.

FIG. 2 is a schematic illustration of a structure in the data store according to an embodiment of the present invention.

FIG. 3 is a schematic diagram of a method for accessing packets contained in the data store according to an embodiment of the present invention.

FIG. 4 is a flow chart illustrating processing performed according to the method for accessing packets contained in the data store according to an embodiment of the present invention.

### DETAILED DESCRIPTION OF THE ILLUSTRATED EMBODIMENTS

Embodiments of a method, apparatus and system for accessing data in a data store are described herein. In the following description, numerous specific details are described to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail but are nonetheless encompassed within the scope of the invention.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in this specification do not necessarily all refer to the same embodiment. Furthermore, the particular features, structures, or characteristics may be combined in any suitable manner in one or more embodiments.

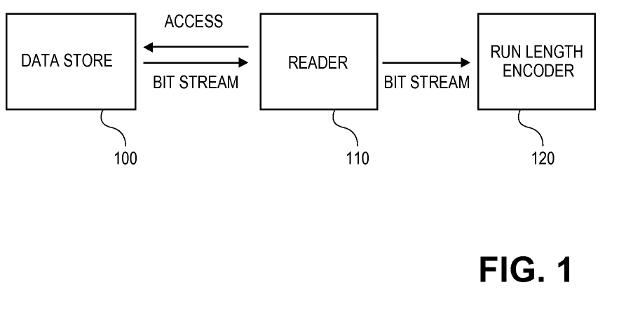

Referring to FIG. 1, a schematic diagram of an embodiment of a method and system for accessing packets contained in a data store is shown. The system comprises a data store, a reader, a run length encoder and is located on-board a spacecraft. The data store serves as a means for recording housekeeping telemetry data in the form of CCSDS packets. Individual packets correlate to subsystems so they are a mix of different parameters and data types. The field length for each parameter is fixed but the length varies for each one. Different packets are written into the data store in time generated order. This causes more mixing of parameters and data types. The reader is a means for accessing packets contained in the data store, wherein the reader reads data stored as fixed length messages consisting of fields fixed in position and bit length and in which each field corresponds to a particular measurement, e.g. typical CCSDS housekeeping packets. Although the method can be applied to any set of messages having such a structure S, e.g. lines in a file, the term “packet” is used to refer to any messages having these qualities.

The reader is further capable of accessing the data store in such a way as to make an outgoing bit stream highly compressible using a very simple compression algorithm. The aim of the reader is to achieve a stream of data which reduces the number of bit level transitions that the stream experiences. This can then be easily compressed by the run length encoder. The run length encoder is capable of receiving the bit stream from the reader and encodes the bit stream using the compression algorithm. The run length encoder works by storing consecutive identical data values as one data value and a count. It then passes the compressed bit stream to a receiving means such as a control centre.

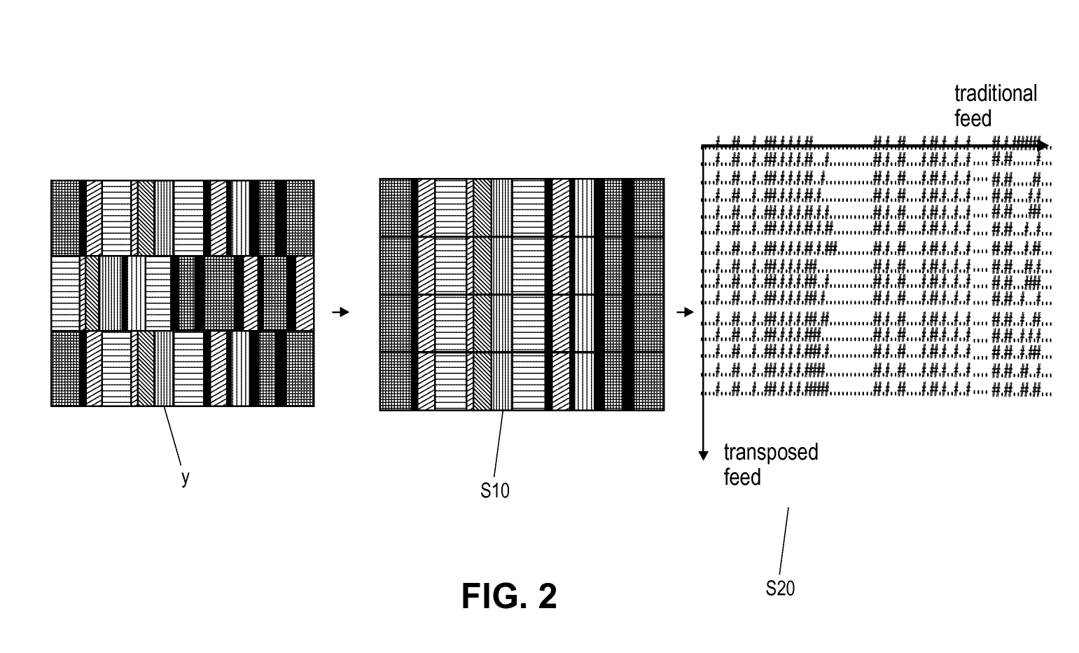

FIG. 2 illustrates an embodiment of a method for accessing packets contained in the data store relies on exploiting the structured nature of CCSDS packets when applied to the housekeeping data required for spacecraft control. Different packets are written into the data store in time generated order. This causes mixing of parameters and data types. Therefore, according to the method for accessing packets contained in the data store, in a first step (S10), packets are selected from the data store such that packets of a same packet type are grouped together. In step S20, the selected group of packets of the same packet type is then read from the data store such that a transposed feed is created.

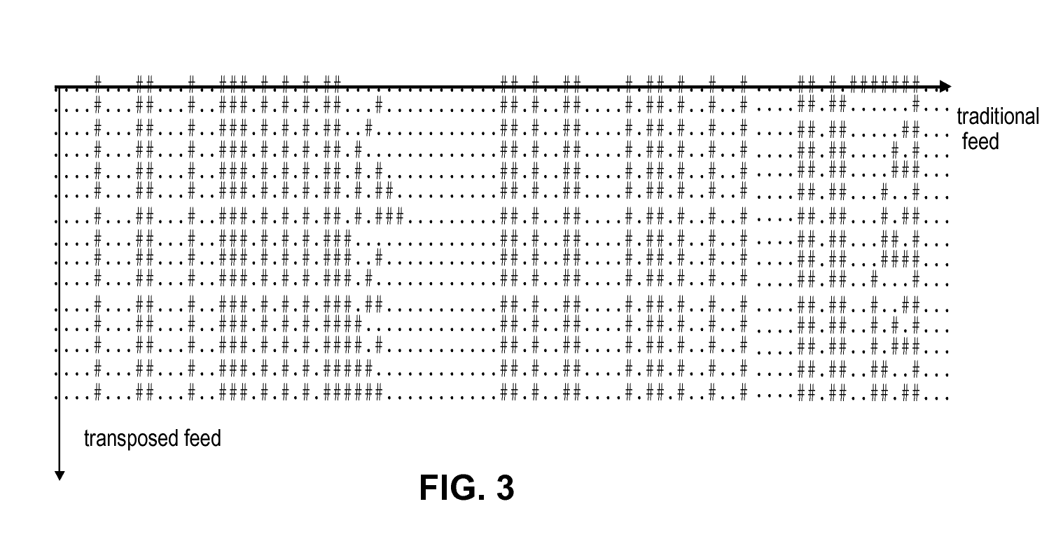

FIG. 3 illustrates an embodiment of the effect of the method shown in FIG. 2. The diagram shows a data store where a pound sign “#” represents one and a period “.” represents zero. The traditional feed to a compression algorithm would be through the packet, i.e. horizontally, which experiences many transitions. By changing the feed to read the same bit x of each packet y before moving to the next bit, i.e. vertically, the number of transitions can be considerably reduced. This method exposes exploitable characteristics of housekeeping data to simple compression algorithms. For example if a parameter is allocated sixteen bits of a packet y and its value evolves slowly many of those sixteen bits will remain identical in the transposed feed. The transposed feed is then passed to a run length encoder (not shown), which compresses it very effectively without requiring much processing power.

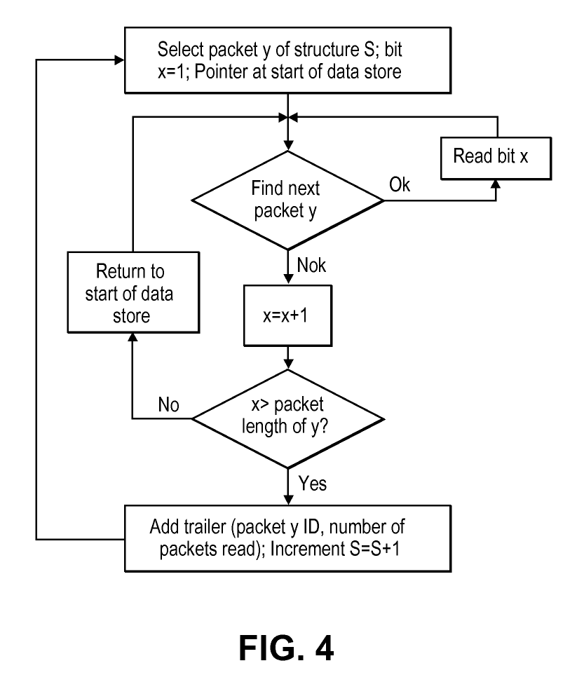

FIG. 4 illustrates an embodiment of a method for accessing packets contained in the data store, as follows. First a number of packets of a predetermined packet type is determined forming a structure S consisting of a plurality of said packets of the predetermined packet type in the data store 100. Then a first structure S of the set of structures S is selected. Further, a bit counter is set to x=1 and a pointer is set to point at the start of the data store. A first bit x of the first packet y of the first structure S is read by the reader. The reader then determines whether there is a next packet y. If yes, the reader moves on to the next packet y of the first structure S and reads the first bit. The reader continues reading the first bit x of each packet y of the first structure S until the last packet y of the first structure. After the last packet y of the first structure S has been read, no next packet y can be determined, therefore x is incremented by one (x=x+1). If the value of x is less than the packet length of packet y at this point, the reader returns to the first packet y of the first structure S and a second bit x+1 of the first packet y of the first structure S is read.

The reader then moves on to the next packet y of the first structure S and reads the second bit. The reader continues reading the second bit x of each packet y of the first structure S until the last packet y of the first structure. The above mentioned steps of consecutively reading a subsequent bit x+n, (where n is incremented by one each time the last packet y of the first structure S has been read) of each packet y of the first structure S is then carried out until a final bit x of each packet y of the first structure S is read. After the final bit x of each packet y has been read, the value of x is greater than the packet length of packet y, so the reader stops. The reader then adds an identifier to the stream indicating the first structure S was read and the number of packets processed.

Then a next structure S of the set of structures is selected and the above mentioned method steps are repeated, i.e. reading a first bit x of each packet y of the next structure S consecutively, then reading a subsequent bit x+n of each packet y of the next structure S consecutively until a final bit x of each packet y is read and adding an identifier to the stream indicating the next structure S was read and the number of packets processed. The above mentioned method steps are repeated for all structures in the data store.

The above mentioned method is applicable to any field that requires recorded housekeeping data from a remote site to be sent back to a control centre and there are tight constraints on power, processing power, communication time or response time. The method can be applied to any data store using fixed length packets, consisting of fields fixed in position and bit length and in which each field corresponds to a particular measurement. Therefore it is not restricted to CCSDS packets or spacecraft only.

Although the invention was conceived for use with CCSDS packets, the method and apparatus can be applied to any data store using fixed length packets, consisting of fields fixed in position and bit length and in which each field corresponds to a particular measurement.

The above description of illustrated embodiments of the invention, including what is described in the abstract, is not intended to be exhaustive or to limit the invention to the precise embodiments disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description.

The terms used in the following claims should not be interpreted to limit the invention to the specific embodiments disclosed in the specification and the claims. Rather, the scope of the invention is to be determined entirely by the following claims, which are to be interpreted according to established doctrines of claim interpretation.

1. A method for accessing messages contained in a data store, the method comprising:
determining a number of messages of a predetermined message type forming a structure consisting of a plurality of said messages of the predetermined message type in the data store;
selecting the structure;
reading a first bit of each message of said structure consecutively; and
reading a subsequent bit (x+n) of each message of said structure consecutively until a final bit of each message is read.

2. The method for accessing messages contained in a data store of claim 1, wherein determining the number of messages of the predetermined message type forming said structure consisting of the plurality of said messages of a predetermined message type in the data store, selecting the structure, reading the first bit (x) of each message of said structure consecutively, and reading the subsequent bit (x+n) of each message of said structure consecutively until the final bit of each message is read are performed for each structure in the data store.

3. The method for accessing messages contained in a data store of claim 1, wherein each of said messages of the predetermined message type comprises a predetermined message field pattern.

4. The method for accessing messages contained in a data store of claim 1, wherein by accessing the messages in the data store, a bit stream is created.

5. The method for accessing messages contained in a data store of claim 1, wherein the messages are data packets.

6. The method for accessing messages contained in a data store of claim 5, wherein the data packets contain CCSDS housekeeping data.

7. The method for accessing messages contained in a data store of claim 1, wherein the bit stream exploits a structured nature of CCSDS housekeeping packets when applied to housekeeping data required for spacecraft control.

8. The method for accessing messages contained in a data store of claim 1, wherein when selecting the structure, the messages contained in the structure are read according to the time generated order of the messages in the data store.

9. The method for accessing messages contained in a data store of claim 1, wherein after the final bit of each message of the structure has been read, an identifier is added indicating that said number of messages for the structure were read.

10. The method for accessing messages contained in a data store of claim 1, wherein determining the number of messages of the predetermined message type forming said structure consisting of the plurality of said messages of a predetermined message type in the data store, selecting the structure, reading the first bit (x) of each message of said structure consecutively, and reading the subsequent bit (x+n) of each message of said structure consecutively until the final bit of each message is read are performed by a reader.

11. The method for accessing messages contained in a data store of claim 1, wherein the bit stream is passed to an encoding means for compressing the bit stream.

12. The method for accessing messages contained in a data store of claim 11, wherein the encoding means is a run length encoder.

13. The method for accessing messages contained in a data store of claim 11, wherein the bit stream is passed to the encoding means by the reader.

14. The method for accessing messages contained in a data store of claim 1, wherein the data store is a packet store.

15. The method for accessing messages contained in a data store of claim 1, wherein each message is fixed in length.

16. The method for accessing messages contained in a data store of claim 1, wherein each message consists of fields fixed in position and bit length.

17. The method for accessing messages contained in a data store of claim 16, wherein each field corresponds to a measurement.

18. The method for accessing messages contained in a data store of claim 17, wherein the measurement is performed by a sensor, an instrument or a device monitor.

19. An apparatus for accessing messages contained in a data store, the apparatus comprising:
determining means for determining a number of messages of a predetermined message type forming a structure consisting of a plurality of said messages of the predetermined message type in the data store;
selecting means for selecting the structure;
reading means for reading a first bit (x) of each message of said structure consecutively; and
reading means for reading a subsequent bit (x+n) of each message of said structure consecutively until a final bit of each message is read.

20. The apparatus for accessing messages contained in a data store of claim 19, wherein the apparatus is formed by a reader.

21. The apparatus for accessing messages contained in a data store of claim 19, wherein the apparatus is capable of providing a bit stream.

22. A system for accessing messages contained in a data store, the system comprising:
a data store;
determining means for determining a number of messages of a predetermined message type forming a structure consisting of a plurality of said messages of the predetermined message type in the data store;
selecting means for selecting the structure;
reading means for reading a first bit (x) of each message of said structure consecutively;
reading means for reading a subsequent bit (x+n) of each message of said structure consecutively until a final bit of each message is read; and
encoding means for compressing a bit stream received from the reading means.

23. The system for accessing messages contained in a data store of claim 22 wherein the encoding means is a run length encoder.
